(19) United States
(12) Patent Application Publication
(10) Pub. No.: US 2004/0013356 A1
(43) Pub. Date: Jan. 22, 2004

(54) Tunable filter applied in optical networks

(76) Inventors: Jen-Chih Wang, Chung Ho City (TW); Sean Chang, Taoyuan City (TW)

Correspondence Address: BAKER & BOTTS, 30 ROCKEFELLER PLAZA, NEW YORK, NY, 10112

(21) Appl. No.: 10/307,794

(22) Filed: Dec. 2, 2002

(30) Foreign Application Priority Data
Jul. 22, 2002 (TW) 91116302

(51) Int. Cl. G02B 6/26

(52) U.S. Cl. 385/27

(57) ABSTRACT

A tunable filter applied in fiber optical communication networks having a Fabry-Perot Cavity and a reflector is described. The optical light beam passes through the Fabry-Perot Cavity twice to reduce cross-talk and maintain a wide pass-band. The optical thickness between the two reflection faces of the Fabry-Perot Cavity is adjustable so as to filter the desired wavelength.

### FIELD OF THE INVENTION

The present invention relates to an optical filter, and more particularly, to a tunable optical filter.

### BACKGROUND OF THE INVENTION

Optical fiber technology has expanded explosively into communications over the past quarter century. The optical fiber is often seen as a perfect transmission medium with almost limitless bandwidth relative to copper wire technology. Optical fibers guide light from one point to another. Single optical fibers can carry data for data communication applications or carry high-speed signals over long distances for telecom communications. Wavelength-division multiplexing (WDM) is a simple means to increase the capacity of any single optical fiber and it is easy to upgrade and expand capacity by adding more wavelengths. A key technology for controlling light in WDM systems is the optical filter.

There are many types of filters. The most common and useful are thin-film filters that use many thin layers of dielectric material, with alternating high and low index of refraction, that give the thin-film filter its desired wavelength-dependent reflection and transmission characteristics.

Reference is made to FIG. 1. A typical thin-film filter 100 consists of a glass surface with many thin films. The thin-film filter 100 permits light with a specific wavelength to pass through and reflects other light lacking the specific wavelength. As shown in FIG. 1, a light beam with a λ₁ to λ_{N} wavelength illuminates the thin-film filter 100. If the thin-film filter 100 only permits light with a wavelength of λ₂ to pass through, the light with wavelengths λ₁, λ₃ to λ_{N} are reflected.

Fiber Bragg gratings (FBGs), as shown in FIG. 2, consist of a region in which the optical index of refraction of the fiber varies periodically between high and low. For example, a specific wavelength (λ₂ ) which matches the period is reflected by the Bragg gratings while others are transmitted.

As shown in FIG. 3, an array waveguide grating (AWG) uses an array of optical waveguides in which the lengths of adjacent waveguides differ by a fixed amount. The input light from a single fiber illuminates all these waveguides, and because the waveguides are of different lengths, the phase of the light (at the output end of the array of waveguides) varies by a fixed amount, from one waveguide to the next. Optical interference occurs when the wavelength matches the path difference. Therefore, the specific wavelength illuminates the output fibers. As shown in FIG. 3, a light with a wavelength of λ₁ to λ_{N} illuminates the array waveguide gratings, which filter these lights with respect to wavelengths of λ₁ to λ_{N} into the output ports.

The above technologies all have their respective drawbacks. For example, in tunable filters, thin film filter technology occupies a large space, FBGs are too sensitive to temperature, and AWGs consume a lot of energy.

### SUMMARY OF THE INVENTION

According to the above descriptions of the prior art, although the thin-film filter may work well for filtering wavelengths, it is disadvantageously large. On the other hand, the Fiber Bragg gratings (FBG) and the array waveguide gratings (AWG) may both become tunable filters by controlling the temperature to change the index of refraction or the diffraction pattern, respectively. However, the two kinds of filters have a common problem in that temperature control is difficult. Therefore, the present invention provides a Fabry-Perot Cavity tunable filter having low cross-talk and high pass-band for application in a fiber optical communication network that can resolve the above problems.

It is an object of the present invention to provide a Fabry-Perot Cavity tunable filter that has a low sensitivity to temperature and is small. Specially, the Fabry-Perot Cavity can be easily build by MEMS (Micro-Electro-Mechanical-System) technology. Furthermore, the filter of the present invention is able to precisely filter light having the desired wavelength.

In accordance with the apparatus of the present invention, a tunable filter applied in optical networks comprises a Fabry-Perot Cavity and a reflector. An optical light beam passes through the Fabry-Perot Cavity twice to reduce the cross-talk and maintain the wide pass-band. Furthermore, the optical thickness between the two reflection surfaces of the Fabry-Perot Cavity is adjustable to filter the desired wavelength. Also, the Fabry-Perot Cavity and reflector are not parallel, so that the Fabry-Perot Cavity and the reflector can be installed with an angle. The reflection beam reflected from the Fabry-Perot Cavity and the reflection beam reflected from the reflector are also not parallel. Therefore, the isolation between light beam is very high.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic diagram of a conventional thin-film filter;

FIG. 2 is a schematic diagram of a conventional Fiber Bragg grating (FBG);

FIG. 3 is a schematic diagram of a conventional array waveguide grating (AWG);

FIG. 4A is a schematic diagram of a Fabry-Perot Cavity used in the present invention;

FIG. 4B is a schematic optical power intensity distribution diagram of a light passing through a Fabry-Perot Cavity according to the present invention;

FIG. 5A is a schematic diagram of a light passing through two Fabry-Perot Cavities according to the present invention;

FIG. 5B is a schematic optical power intensity distribution diagram of a light passing through two Fabry-Perot Cavities according to the present invention;

FIG. 6 is a schematic diagram according to the first preferred embodiment of the present invention, which comprises a Fabry-Perot Cavity and a reflector;

FIG. 7 is a schematic diagram according to the second preferred embodiment of the present invention, which comprises a Fabry-Perot Cavity, a reflector and a three-fiber collimator; and

FIG. 8 is a schematic diagram according to the third preferred embodiment of the present invention, which comprises a Fabry-Perot Cavity and a triangular prism reflector.

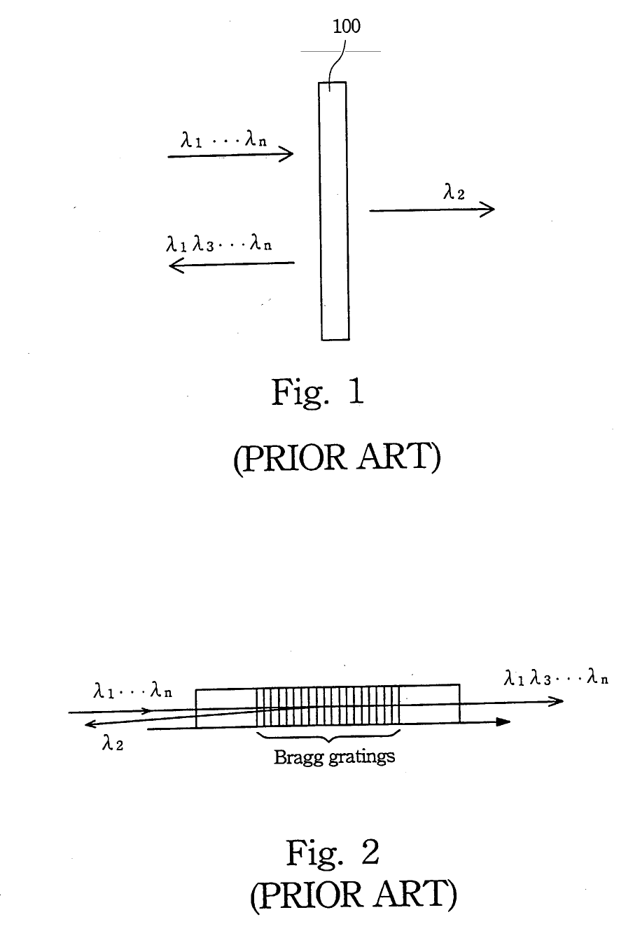

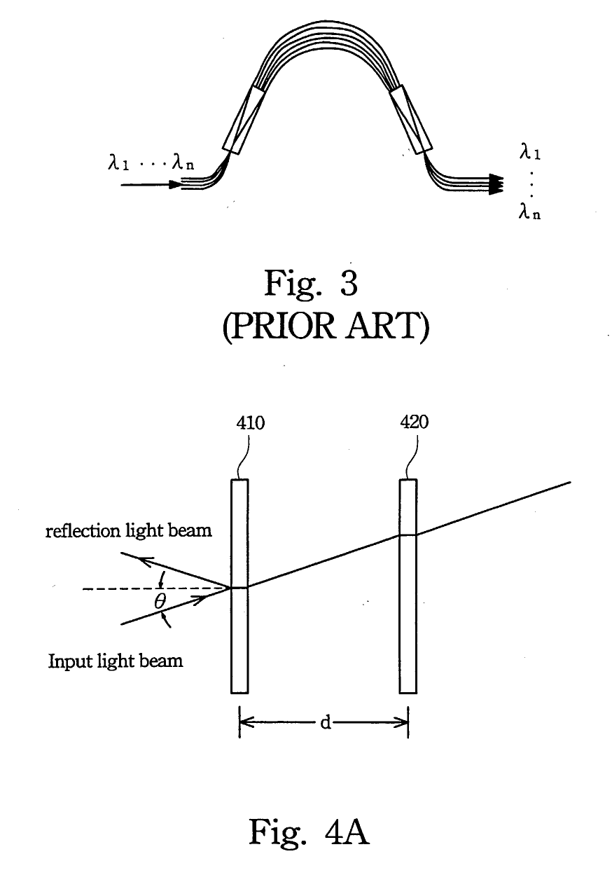

### DETAILED DESCRIPTION OF THE PREFERRED EMBODIMENTS

Without limiting the spirit and scope of the present invention, the apparatus of a tunable filter applied in fiber optical communication networks proposed in the present invention is illustrated with three preferred embodiments. Skilled artisans, upon acknowledging the embodiments, can apply the apparatus of the present invention to any kind of fiber optical communication network to reach the low cross-talk and high pass-band optical characteristic. In accordance with the apparatus of the present invention, a Fabry-Perot Cavity and a reflector are used to build the tunable filter of the present invention. The optical light beam passes through the Fabry-Perot Cavity twice to achieve the optical characteristic of low cross-talk and to maintain a wide pass-band. Furthermore, the optical thickness between the two reflection surfaces of the Fabry-Perot Cavity is adjustable to filter the specific wavelength. Also, the Fabry-Perot Cavity and reflector are not parallel, so that the Fabry-Perot Cavity and the reflector are installed with an angle. The reflection beam reflected from Fabry-Perot Cavity and the reflection beam reflected from reflector are also not parallel. Therefore, the isolation between light beams is very high.

The tunable filter of the present invention has a low sensitivity to temperature and is small. Furthermore, by changing the optical thickness of Fabry-Perot Cavity, the filter of the present invention exactly filters the light having the desired wavelength. The application of the present invention is not limited by the following embodiments.

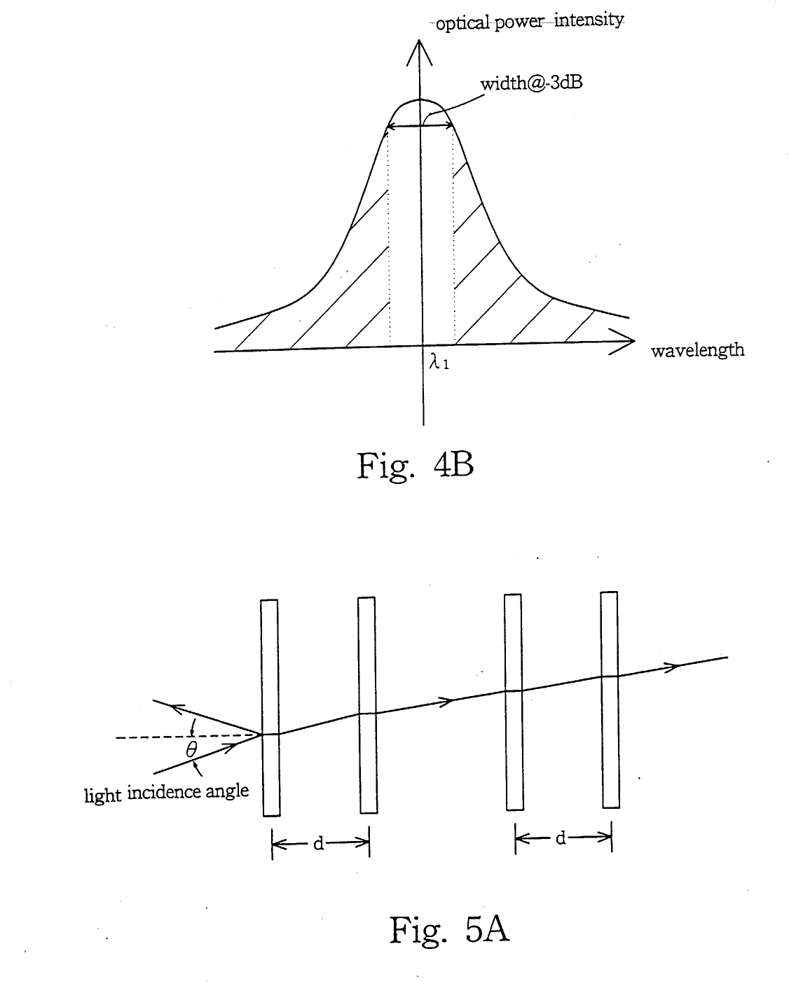

Reference is made to FIG. 4A. A schematic diagram of the Fabry-Perot Cavity applied to the present invention is shown. The Fabry-Perot Cavity consists of two surfaces 410 and 420 with partial reflectance, separated by a small optical thickness d of about several microns. Base on the Fabry-Perot interferometer theory, incident light undergoes multiple reflection between the two coated surfaces which define the cavity. When there is no phase difference between the emerging wavefronts, interference between these wavefronts produces a transmission maximum. This occurs when the optical path difference is an integral number of whole wavelengths, i.e. when mλ=2*d*cos(θ), where m is an integer, d is the optical thickness and θ is the angle of incidence. At other wavelengths, destructive interference of the transmitted wavefronts reduces the transmitted intensity towards zero.

When an incident light beam having a plurality of wavelengths illuminates the Fabry-Perot cavity, only a wavelength which matches the condition (mλ=2*d*cos(θ)) passes through the Fabry-Perot cavity, while other wavelengths are reflected.

An optical power intensity distribution diagram for a light beam illuminating the Fabry-Perot Cavity is shown in FIG. 4B. The maximum optical power exists in a specific wavelength λ₁ which has a width of band. For fiber optical communication application, the width of band is defined as width @-3dB. When the light beam passes through the Fabry-Perot Cavity, the width @-3dB is too large and creates a large cross-talk which is not acceptable in fiber optical communication.

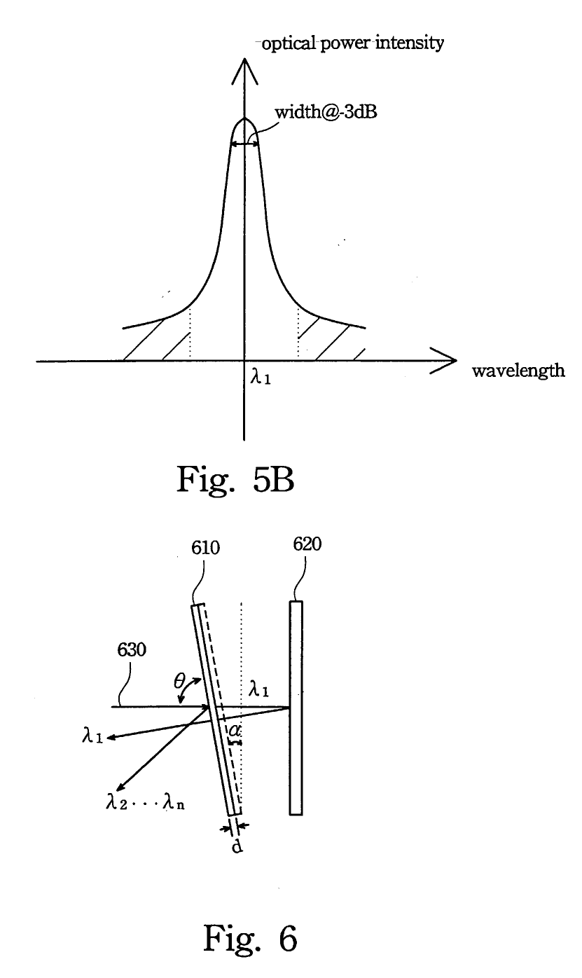

For reducing the width of the spectrum, which means the optical power intensity distribution focuses more on the specific wavelength λ₁, the light beam is guided to pass through the Fabry-Perot Cavity twice, as shown in FIG. 5A. A light beam is guided to passthrough two Fabry-Perot Cavities. The two Fabry-Perot Cavities have the same optical thickness between the two reflective surfaces. The optical power intensity distribution diagram is shown in FIG. 5B. Therefore, it is more focused on the specific wavelength λ₁, and the width @-3dB is also smaller.

However, it is very difficult to adjust the respective optical thickness of the two Fabry-Perot Cavities simultaneously. If the optical thickness of the two Fabry-Perot Cavities are not the same, the output wavelengths outputted from the two Fabry-Perot Cavities are shifted and the power is reduced. Therefore, a Fabry-Perot Cavity and a reflector are used to make a tunable filter in accordance with the present invention. This tunable filter guides the optical light beam through the Fabry-Perot Cavity first. Then, the reflector reflects the optical light beam and the reflected optical light beam is guided into the Fabry-Perot Cavity again. Therefore, the light beam passes through the same Fabry-Perot Cavity twice, and the optical thickness is always the same. The problem of adjusting the respective optical thickness of the two Fabry-Perot Cavities is resolved.

FIG. 6 shows the first embodiment of the Fabry-Perot Cavity tunable filter in accordance with the present invention. This tunable filter comprises a Fabry-Perot Cavity 610 and a reflector 620. The reflector 620 is a mirror. Additionally, the Fabry-Perot Cavity 610 and the reflector 620 are not parallel. That is, the Fabry-Perot Cavity 610 and the reflector 620 are installed with an angle. The reflection beam reflected from Fabry-Perot Cavity and the reflection beam reflected from reflector are also not parallel. Therefore, the isolation between light beams is very high. Furthermore, the optical thickness between the two reflective surfaces of the Fabry-Perot Cavity is also adjustable as shown in this FIG. 6 where the left reflective surfaces is fixed and the right reflective surfaces is adjustable to the dotted line.

If the optical thickness of the tunable Fabry-Perot Cavity 610 matches the condition of mλ=2*d*cos(θ)), then the wavelength of λ₁ passes through the cavity 610. When an optical light beam 630 having wavelengths λ₁ to λₙ illuminates the tunable Fabry-Perot Cavity 610, the light beam having wavelength λ₁ passes through the Fabry-Perot Cavity 610 and the light beam having wavelengths λ₂ to λₙ is reflected by the Fabry-Perot Cavity 610. When the optical signal having wavelength λ₁ hits the reflector 620, this optical light beam with wavelength λ₁ is reflected and enters the tunable Fabry-Perot Cavity 610 again. Therefore, the output optical light beam power intensity is more focused on the center of the wavelength λ₁.

Thus, in accordance with the apparatus of the present invention, a tunable filter comprising a Fabry-Perot Cavity and a reflector guides the received light through the Fabry-Perot Cavity twice to focus more the optical power on the wavelength λ₁. Additionally, it is not necessary to use two Fabry-Perot Cavities. Therefore, the problem for adjusting the respective optical thickness of the two Fabry-Perot Cavities simultaneously is resolved.

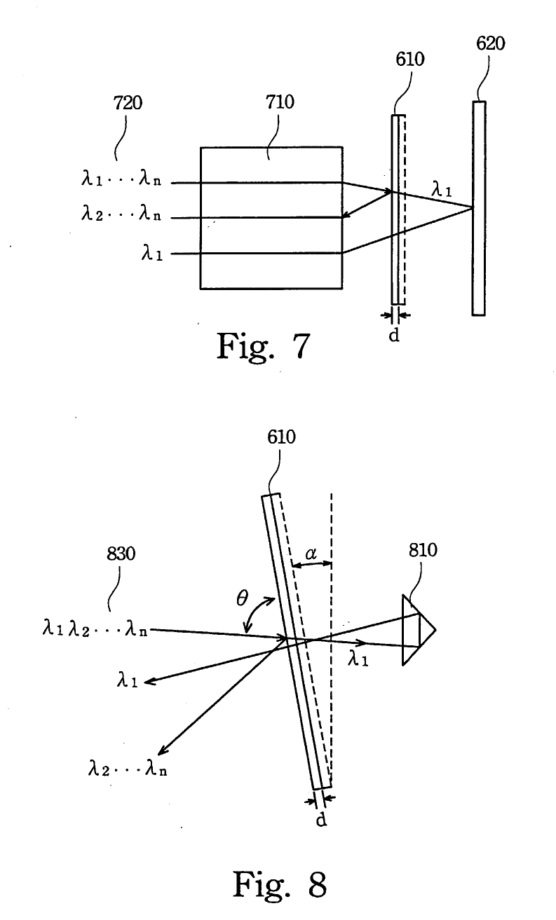

On the other hand, the angle α between the tunable Fabry-Perot Cavity 610 and the reflector 620 may be changed to any degree to separate the light beams which is reflected by both Fabry-Perot Cavity 610 and reflector 620. The isolation status is improved by adjusting the illumination angle α between the tunable Fabry-Perot Cavity 610 and the reflector 620. FIG. 7 shows the second embodiment of the tunable filter in accordance with the present invention. The main difference between the first and second embodiments is that a three-fiber collimator 710 is used to receive the reflected light beams, which are reflected by both of the Fabry-Perot Cavity 610 and reflector 620. As described in the first embodiment of the present invention, the optical thickness d between the two reflective surfaces of the tunable Fabry-Perot Cavity 610 is also adjustable.

If the optical thickness of the tunable Fabry-Perot Cavity 610 surfaces match the condition of mλ₁=2*d*cos(θ)), then an optical light beam having the wavelength λ₁ will pass through the cavity 610. When a optical light beam 720 having wavelengths λ₁ to λₙ is guided from the first fiber of the three-fiber collimator 710 to illuminate the tunable Fabry-Perot Cavity 610, the light beams having wavelengths λ₂ to λₙ are reflected and received by the second fiber of the three-fiber collimator 710. On the other hand, only the optical light beam having wavelength λ₁ passes through the Fabry-Perot Cavity 610. When the optical light beam having wavelength λ₁ hits the reflector 620, the optical light beam is reflected and enters the tunable Fabry-Perot Cavity 610 again. Therefore, the optical light beam power intensity is more focused on the center of the wavelength λ₁. The optical signal having wavelength λ₁ is received by the third fiber of the three-fiber collimator 710.

Therefore, in accordance with the second embodiment of the present invention, the received light may also be guided to pass through the Fabry-Perot. Cavity 610 twice to focus more the optical power on the center of wavelength λ₁. On the other hand, the three-fiber collimator 710 is used in the second embodiment to receive the light beam reflected by the Fabry-Perot Cavity 610 and the reflector 620. FIG. 8 shows the third embodiment of the tunable filter, which comprises a Fabry-Perot Cavity 610 and a reflector 810 in accordance with the present invention. The main difference between the first and third embodiments is that the reflector 810 is a triangular prism. The optical thickness d between the two reflective surfaces of the tunable Fabry-Perot Cavity 610 is also adjustable.

If the optical thickness d between the two reflective surfaces of the tunable Fabry-Perot Cavity 610 causes the optical signal having wavelength λ₁ to pass through, when a light 830 having wavelengths λ₁ to λₙ illuminates the tunable Fabry-Perot Cavity 610, the light having wavelengths λ₂ to λₙ is reflected by the Fabry-Perot Cavity 610. When the optical light beam having wavelength λ₁ hits the triangular prism 810, the optical light beam is reflected and enters the tunable Fabry-Perot Cavity 610 again. Therefore, the optical power is more focused on the center of the wavelength λ₁. As the first and second embodiment described, the Fabry-Perot cavity also turns an angle α to separate the reflection light beams, which are reflected by both the Fabry-Perot Cavity 610 and the reflector 810. The isolation status is also improved.

There are many advantages to the present invention. First, the tunable filter comprises a Fabry-Perot Cavity and a reflector in accordance with the present invention. This tunable filter may guide the received light beam to pass through the Fabry-Perot Cavity twice to focus more the optical light beam power intensity on the center of a specific wavelength to attain optical characteristics of low cross-talk and high pass-band. It is not necessary to use two Fabry-Perot Cavities. Therefore, the problem of respectively adjusting the optical thickness of the two Fabry-Perot Cavities simultaneously, is resolved.

Additionally, this tunable filter in accordance with the present invention has a low sensitivity to temperature and is small. Specially, the Fabry-Perot Cavity can be easily built by MEMS (Micro-Electro-Mechanical-System) technology. Compared with the conventional optical fibers, the thin-film filters, the Fiber Bragg gratings (FBG) and the array waveguide gratings (AWG), the tunable filters of the present invention resolve the problem of the thin-film filter being too big and of the Fiber Bragg gratings (FBG) and the array waveguide gratings (AWG) both being difficult to control by temperature.

As is understood by a person skilled in the art, the foregoing preferred embodiments of the present invention are illustrative of the present invention rather than limiting of the present invention. They are intended to cover various modifications and similar arrangements included within the spirit and scope of the appended claims. For example, the reflector is not only the mirror and the triangular prism as described in the above and other optical devices having a reflection function also may be used in the present invention, the scope of which should be accorded the broadest interpretation so as to encompass all such modifications and similar structure.

What is claimed is:

1. A tunable filter applied in the optical networks, said tunable filter comprising:
a resonant cavity for receiving an illuminating optical signal having a plurality of wavelengths, wherein said resonant cavity has two surfaces separated by a distance d, the illuminating optical signal having a specific wavelength (λ) resonates between said two surfaces of said resonant cavity and outputs a first resonant signal from said resonant cavity, and another illuminating optical signal lacking the specific wavelength is reflected by said resonant cavity; and
a reflective device for reflecting said first resonant signal to said resonant cavity, wherein said first resonant signal resonates again in said resonant cavity and outputs a second resonant signal from said resonant cavity;
wherein one of said two surfaces of said resonant cavity is movable to adjust the distance d to output said corresponding first resonant signal when said optical signal having a plurality of wavelengths illuminates said resonant cavity.

2. The tunable filter according to claim 1, wherein said specific wavelength matches a condition of mλ=2*d*cos(θ), wherein m is an integer, d is the distance separating said two surfaces of said resonant cavity, and θ is an angle of incidence of said illuminating optical signal.

3. The tunable filter according to claim 1, wherein air exists between said two surfaces of said resonant cavity.

4. The tunable filter according to claim 1, wherein said tunable filter further comprises a receiver for receiving said second resonant signal.

5. The tunable filter according to claim 2, wherein said receiver is a three-fiber collimator.

6. The tunable filter according to claim 1, wherein said resonant cavity is a Fabry-Perot Cavity.

7. The tunable filter according to claim 1, wherein said reflective device is a mirror.

8. The tunable filter according to claim 1, wherein said reflective device is a triangular prism.

9. The tunable filter according to claim 1, wherein said resonant cavity is adjusted to form any angle with said illuminating optical signal to separate said second resonant signal from said reflected optical signals lacking the specific wavelength.

10. A tunable filter applied in the optical networks, said tunable filter comprising:
a resonant cavity for receiving an illuminating optical signal having a plurality of wavelengths, wherein said resonant cavity has two surfaces separated by a distance d, the illuminating optical signal having a specific wavelength (λ) resonates between said two surfaces of said resonant cavity and outputs a first resonant signal from said resonant cavity, and another illuminating optical signal lacking the specific wavelength is reflected by said resonant cavity;
a reflective device for reflecting said first resonant signal to said resonant cavity; and
a receiver for receiving the second resonant signal and the illuminating optical signal lacking said specific wavelength reflected by said resonant cavity, wherein said second resonant signal occurs when said resonant cavity receives said first resonant signal and resonates in said resonant cavity again;
wherein one of said two surfaces of said resonant cavity is movable to adjust the distance d to output said corresponding first resonant signal when said optical signal having a plurality of wavelengths illuminates said resonant cavity.

11. The tunable filter according to claim 10, wherein said specific wavelength matches a condition of mλ=2*d*cos(θ)), wherein m is an integer, d is the distance separating said two surfaces of said resonant cavity, and θ is an angle of incidence of said illuminating optical signal.

12. The tunable filter according to claim 10, wherein air exists between said two surfaces of said resonant cavity.

13. The tunable filter according to claim 10, wherein said receiver is a three-fiber collimator.

14. The tunable filter according to claim 10, wherein said resonant cavity is a Fabry-Perot Cavity.

15. The tunable filter according to claim 10, wherein said reflective device is a mirror.

16. The tunable filter according to claim 10, wherein said reflective device is a triangular prism.

17. The tunable filter according to claim 10, wherein said resonant cavity is modulated to form any angle with said illuminating optical signal to separate said second resonant signal from said reflected optical signals lacking the specific wavelength.

18. A tunable filter applied in the optical networks, said tunable filter comprising:
a Fabry-Perot interferometer having two surfaces separated by a distance d that exists air between the two surfaces, and one of the two surface is movable; wherein when an optical signal having a plurality of wavelengths and having a incidence angle θ illuminates said Fabry-Perot interferometer, a wavelength matching a condition of mλ=2*d*cos(θ) passes through a cavity, while other wavelengths are reflected, where m is an integer; and
a reflective device for reflecting light passing through said Fabry-Perot interferometer back to said same Fabry-Perot interferometer to generate a reflection signal.

19. The tunable filter according to claim 18, wherein said tunable filter further comprises a receiver for receiving said reflection signal.

20. The tunable filter according to claim 18, wherein said tunable filter further comprises a receiver and the receiver is a three fiber collimator.

21. The tunable filter according to claim 18, wherein said Fabry-Perot interferometer is a Fabry-Perot Cavity.

22. The tunable filter according to claim 18, wherein said reflective device is a mirror.

23. The tunable filter according to claim 18, wherein said reflective device is a prism.

24. The tunable filter according to claim 18, wherein said Fabry-Perot interferometer and said reflective device are not parallel, and have an angle therebetween to separate said reflection light beams reflected by the Fabry-Perot interferometer and the reflective device.
